(19) United States
(12) Patent Application Publication
(10) Pub. No.: US 2009/0121633 A1
(43) Pub. Date: May 14, 2009

(54) METAL HALIDE LAMP

(75) Inventors: Hendrik Anton Van Esveld, Eindhoven (NL); Martinus Joseph Maria Kessels, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,739

(22) PCT Filed: Oct. 20, 2005
(86) PCT No.: PCT/IB05/53439

§ 371 Date: Apr. 23, 2007

(30) Foreign Application Priority Data
Oct. 26, 2004 (EP) 04105295.2
Jun. 14, 2005 (EP) 05105214.0

(51) Int. Cl. H01J 61/04

(52) U.S. Cl. 313/621

(57) ABSTRACT

A metal halide lamp comprising a discharge vessel enclosing a discharge space of volume V(cm) and containing an ionizable gas filling comprising Hg in a quantity of mass m(g) and at least a metal halide, wherein in said discharge space two electrodes are arranged whose tips have a mutual interspacing EA so as to define a discharge path between them, the discharge space having a length L(mm) measured along the discharge path and a largest diameter D(mm) square thereto, wherein the ratio X=L/D satisfies the relation 0.7<X<6, and, wherein 0.28 3.71 D′_{*x}<_(m/V)<_D′*

The invention relates to a metal halide lamp comprising a discharge vessel enclosing a discharge space of volume V(mm³) containing an ionizable gas filling comprising Hg in a quantity of mass m(mg) and at least a metal halide, wherein in said discharge space two electrodes are arranged whose tips have a mutual interspacing EA so as to define a discharge path between them, the discharge space having a length L(mm) measured along the discharge path and a largest diameter D(mm) square thereto, wherein the ratio X=L/D satisfies the relation 0.7<X<6.

Such a lamp is known from EP-A-0 215 524. This known lamp has a rated power of 160 W, the electrode distance EA is 10 mm and its discharge vessel, having an inner diameter D of 6.85 mm, contains between 18.2 and 21.8 mg/cm³ mercury, and further a rare earth halide. During operation, the gas filling has an estimated mean temperature of 2800 K. The known lamp has a discharge vessel with a ceramic wall. Ceramic is understood in this description and claims to be a translucent crystalline metal oxide, like monocrystalline sapphire or like densily sintered polycrystalline alumina and yttrium garnet, as well as a translucent polycrystalline metal nitride, like AlN.

A problem with the known lamp is that the lamp life is short, in some cases extremely short, particularly in the case of an embodiment having a high value of the color rendering index for deep red colors R₉. This is caused by the fact that the metal of the electrodes evaporates and is deposited on the discharge vessel, thereby blackening its wall. The light output is decreased to such an extent that the lamp must be replaced after a relatively short period of time. In comparison hereto, it is observed that for lamps having an acceptable maintenance of luminous efficacy (lW) over several 1000 hours or more, the starting value for the color rendering index for deep red commonly is about 0 or even negative.

The object of the invention is to provide a lamp of the above-mentioned type having a longer effective lamp life and/or a better light output during its lifetime.

According to the invention the following relation holds:

$$\sqrt{\frac{0.28}{{D}^{3} * X}} \leq ( m \text{/} V ) \leq \sqrt{\frac{3.71}{{D}^{3} * X}} .$$

The invention applies both to a lamp having a discharge vessel made of quartz or quartz-glass and to a lamp with a ceramic discharge vessel. Experiments have shown that the invention enables lamp embodiments combining values for the general color index Ra in the range of >85 with an initial value of about 40 for the color rendering index for deep red R₉, which additionally have a relatively long lifetime.

The lamp according to the invention has a relatively high mercury filling in the discharge vessel, which has the useful effect that the gas has a relatively high kinematic viscosity and circulates at high speed in the discharge vessel, which has a self-cleaning effect at least on the discharge vessel's wall area between the electrodes. Depending on the EA, the lamp voltage can be anything between for instance 50 and 500 Volts.

The above stated relation is related to the equation that defines the so-called Grashof number, from which it can be derived that in free convecting systems, where (kinematic viscosity)²×(dimension)³ is constant, the convection speed in a fluid will be the same. It is assumed herewith that during operation the gas filling has a mean temperature of 2800 K. The above-mentioned limits are further derived from test results. The lower limit for m/V relates to the minimum convection speed that is necessary for said cleaning effect. The upper limit for m/V relates to the maximum pressure, above which the gas stream becomes turbulent, with little cleaning effect and flickering of the arc (unstable behavior).

For several embodiments of the invented lamp having different values of the ratio X and diameter D(mm) of the discharge space, the ranges for m/V(mg/mm³) in the discharge vessel are given below:

| X | diameter D | m/V minimum | m/V maximum |
|---|---|---|---|
| 0.7 | 1.4 | 0.3818 | 1.39 |
| | 2 | 0.2236 | 0.81 |
| | 3 | 0.1217 | 0.44 |
| | 4 | 0.0791 | 0.29 |
| | 5 | 0.0566 | 0.21 |
| | 6 | 0.0430 | 0.16 |
| 1 | 1.4 | 0.3194 | 1.16 |
| | 2 | 0.1871 | 0.68 |
| | 3 | 0.1018 | 0.37 |
| | 4 | 0.0661 | 0.24 |
| | 5 | 0.0473 | 0.17 |
| | 6.75 | 0.0302 | 0.11 |
| 1.2 | 5 | 0.0432 | 0.16 |
| 1.33 | 3 | 0.0882 | 0.32 |
| 5 | 1.4 | 0.1207 | 0.52 |
| | 2 | 0.0707 | 0.30 |
| | 3 | 0.0385 | 0.17 |
| | 4 | 0.0250 | 0.11 |
| | 5 | 0.0179 | 0.08 |
| | 6 | 0.0136 | 0.06 |
| 6 | 1.4 | 0.1161 | 0.47 |
| | 2 | 0.0680 | 0.28 |
| | 3 | 0.0370 | 0.15 |
| | 4 | 0.0240 | 0.10 |
| | 5 | 0.0172 | 0.07 |
| | 6 | 0.0131 | 0.05 |

In particular, the preferred embodiment according to the invention is a metal halide lamp having a rated power below 100 W, suitable for general lighting purposes. Preferred metal halide salts are NaI and/or TlI. Preferably, the discharge vessel is of tubular shape, which has the advantage of being a well-proven technology in industrial scale lamp manufacturing, and 0.7<X<4. The same advantage is achieved at values of D ranging preferably between 1.4 mm and 8 mm, more preferably between about 2 mm and about 7 mm, so as to limit the maximum pressure within a range for which standard techniques of lamp processing suffice in lamp manufacturing. A relatively small diameter is advantageous to achieve a stable discharge position. A rare earth halide may be present, but in the preferred embodiment of the lamp the discharge space does not comprise a rare earth halide.

In a lamp having a tubular discharge vessel closed off at either side by an end face, the length L is the distance between both end faces taken along the discharge path. For shaped discharge vessels, having a blown-up non cylindrical shape, the length L is the distance between the intersections of the extended discharge path and the tangent at the points where the discharge vessel's wall starts to be convectively curved towards an end.

The diameter D of the discharge space taken at a dedicated location is equivalent to the inner diameter of the discharge vessel taken at the same location.

The above and further aspects of the lamp in accordance with the invention will be explained with reference to a drawing (not to scale), in which

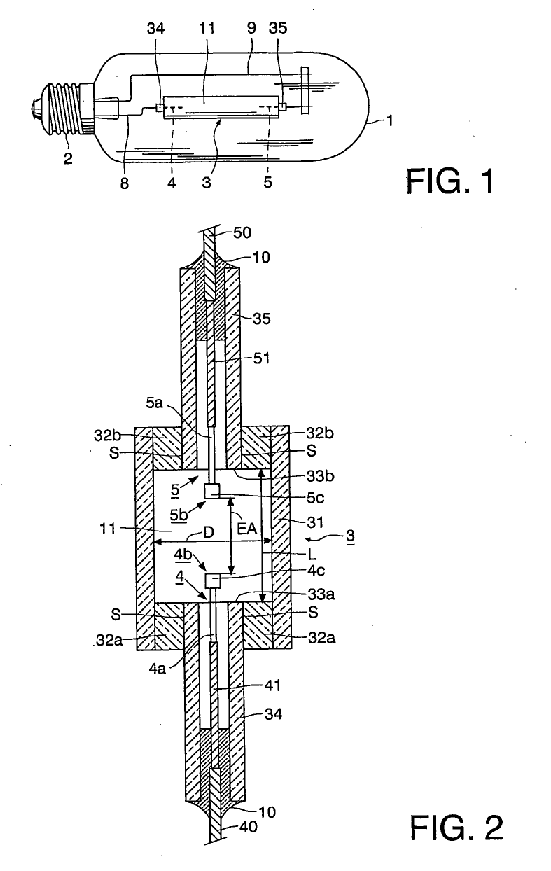

FIG. 1 schematically shows a lamp in accordance with the invention;

FIG. 2 is a detailed representation of the discharge vessel of the lamp in accordance with FIG. 1, and

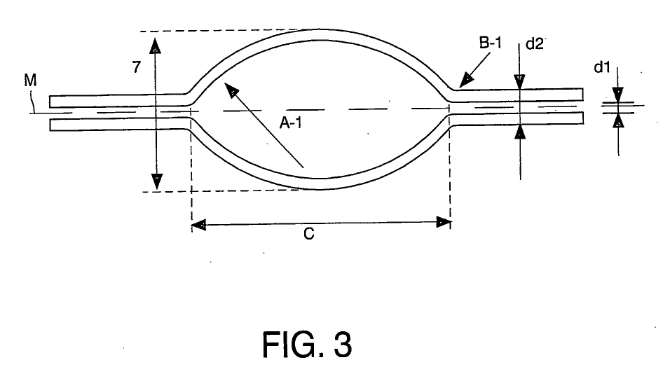

FIG. 3 is a detailed representation of an alternative discharge vessel for a lamp according to the invention.

FIG. 1 and FIG. 2 show a 39 Watt metal-halide lamp provided with a discharge vessel 3 having a ceramic wall which encloses a discharge space 11 of approximately 125 mm³ containing an ionizable filling including 11 mg Hg and 2.5 mg NaI/TlI in a molar ratio ranging from 82/18 to 88/12.

Two electrodes 4, 5 whose coiled tips 4b, 5b are at a mutual distance EA=5 mm are arranged in the discharge space with a length L=6. mm, and the tubular discharge vessel has an internal diameter D=5 mm. Thus X=1.2,

$$\sqrt{\frac{0.28}{{D}^{3} * X}} = 0.0432 and \sqrt{\frac{3.71}{{D}^{3} * X}} = 0.16 .$$

The discharge vessel, whose ceramic wall has a thickness of 0.8 mm, is formed by a cylindrical part which is closed at either side by means of an end wall portion 32a, 32b forming an end face 33a, 33b of the discharge space. The end wall portions each have an opening in which a ceramic projecting (extended) plug 34, 35 is fitted in a gastight manner in the end wall portion 32a, 32b by means of a sintered joint S. The plugs 34, 35 enclose current lead-through conductors 40, 41, 50, 51 to electrodes 4, 5 with a narrow interspace and are connected to the respective lead-through conductors in a gastight manner by means of a melting-ceramic joint 10 near to an end remote from the discharge space. The electrodes 4, 5 are made of tungsten and have a diameter between 150 and 170 microns, the coiled tips 4b, 5b are 0.4 mm long and are formed by a wire with a diameter of 100 microns. The diameter of the electrodes is slightly smaller than in comparable prior art lamps, in order to accommodate the lower lamp current.

The discharge vessel is surrounded by an outer bulb 1 which is provided with a lamp cap 2 at one end. A discharge will extend between the electrodes 4, 5 when the lamp is operating. The electrode 4 is connected to a first electrical contact forming part of the lamp cap 2 via a current conductor 8. The electrode 5 is connected to a second electrical contact forming part of the lamp cap 2 via a current conductor 9.

The current lead-through conductors, which are attached in a well-known way to the respective end plug 34, 35 in a gastight manner by means of the melting-ceramic joint 10 each comprise a highly halide-resistant portion 41, 51 and a portion 40, 50. The parts 40, 50 are connected to the current conductors 8, 9, respectively, in known manner not shown in any detail. The lead-through construction described renders it possible to operate the lamp in any desired burning position.

In an experiment, a conventional 39 W metal halide lamp as described above, having a conventional 3.3 mg Hg filling (m/V=0.0280 mg/mm³), was compared with a 39 W metal halide lamp according to the invention of identical construction comprising 11 mg Hg as part of the filling (m/V=0.0934). Besides Hg the filling of both lamps comprised 2.5 mg NaI/TI in a molar ratio of 88/12. The test results reveal that the conventional lamp shows a 30% decrease in luminous efficacy after 3,000 burning hours, whereas the lamp according to the invention does not show any decrease after more than 15,000 hours. No blackening or corrosion of the wall of the discharge vessel is observed with the lamp according to the invention, and furthermore this lamp shows a high color rendering (Ra 88-89) due to line broadening by the high (mercury) pressure. Some light technical properties of the inventive lamp after a lifetime of 90 hours and 15000 hours, respectively, are listed below:

| | | |
|---|---|---|
| Luminous efficacy (lm/W): | 81 | 87 |
| Col. Rendering index Ra | 89 | 88 |
| Col. rendering index R₉ | 42 | 11 |
| Color temperature Tc (K) | 2664 | 2832 |

In a further embodiment of a lamp according to the invention with a power of 20 W, the discharge space had a largest diameter D of 3 mm, a value of X=1 and a volume of 21.21 mm³. At an amount of 2.5 mg Hg the ratio mN/V was 0.117 mg/mm³. Over an operating period of 10,000 hours the luminous efficacy changed from 59 lm/W to 59.8 lm/W, whilst the value for the general color rendering index Ra was stable at 88. Over the same period the color temperature Tc changed from 2751K into 2697K.

Further successful embodiments have been made, for instance with a length L of 4 mm and a largest diameter D of 3 mm. The lamp with a nominal power of 22 W had a filling of 4.5 mg Hg corresponding to 0.159 mg/mm³. The filling of the lamp further comprised Na/Tl/Dy iodide in a molar ratio of 90/8.6/1.4. In a first series of lamps the salt amount was 4.4 mg. The lamps showed a mean luminous efficacy at 100 hours of 74 lm/W, with a value for the index Ra of 86 and for the index R₉ of 39. After 500 hours the values for said quantities are 69 lm/w, 86 and 48, respectively. A second series of lamps comprised an amount of 5.5 mg Na/Tl/Dy salt. The mean luminous efficacy of these lamps evolved from 68 lm/W at 100 H to 64 lm/W at 500 hours. The index for Ra was stable over the period at 86 and the index for R₉ increased from 57 to 64. In a further embodiment, the length L of the discharge space is 25 mm, with a largest internal diameter of 5 mm.

In an alternative embodiment, the lamp is provided with a shaped discharge vessel having a blown-up non-cylindrical shape. In the specific embodiment shown in FIG. 3, the blown-up non-cylindrical shape is a body with an axis of revolution M having a curved section with a radius A-1 and an outer diameter 7. The discharge vessel has a ceramic wall enclosing a volume V forming the discharge space 11. For the sake of clarity, the electrodes, which extend along the axis M, are not indicated. In this specific embodiment d1 and d2 indicate the outer and inner diameter, respectively, of the projecting plugs into which the electrodes are injected and which are e.g. sealed with a melt-ceramic compound.

Each end of the discharge vessel is connected to one of the respective projecting plugs, which connection is characterized by a convective curvature with radius B-1 towards the respective end of the discharge vessel. In the shown embodiment, the radii are of constant value and the curvatures are sections of circles. For shaped discharge vessels the length L of the discharge space is the distance between the intersections of the extended discharge path, which coincide with the axis M, and the tangent at the points where the discharge vessel's wall starts to be convectively curved towards an end. In the shown embodiment, the length L equals the discharge body length C.

By varying the value of the radius A-1 along the curvature, any desired blown-up non-cylindrical shape can be realized, like for instance ellipsoidal, paraboloid and ovoid. In a different embodiment, the radius A-1 can also be equal or smaller than half the outer diameter 7, leading to a more spherical shape. Depending on the ratio between the discharge body length C and the radius A-1, the form of the discharge body then can vary between a sphere on the one hand and two half spheres connected by a cylindrical part with an outer diameter 7, on the other hand.

A main advantage of these blown-up non-cylindrical designs is that the wall thickness of the discharge vessel can be kept fairly constant, which is advantageous for achieving an even distribution of the temperature over the wall of the discharge vessel. This is furthermore promoted by the fact that in a body of such a shape the volume section between electrode and respective projecting plug is relatively small in comparison with a cylindrical discharge vessel.

The scope of the invention is not limited to the above embodiment. The invention is embodied in each new characteristic and each combination of characteristics. Any reference signs do not limit the scope of the claims. The word “comprising” does not exclude the presence of elements other than those listed in a claim. Use of the word “a” or “an” preceding an element does not exclude the presence of a plurality of such elements.

1. A metal halide lamp comprising a discharge vessel enclosing a discharge space of volume V(mm³) containing an ionizable gas filling comprising Hg in a quantity of mass m(mg) and at least a metal halide, wherein in said discharge space two electrodes are arranged whose tips have a mutual interspacing EA so as to define a discharge path between them, the discharge space having a length L(mm), measured along the discharge path, and a largest diameter D(mm) square thereto, wherein the ratio X=L/D satisfies the relation 0.7<X<6, characterized in that the following relation holds
$$\sqrt{\frac{0.28}{{D}^{3} * X}} \leq ( m \text{/} V ) \leq \sqrt{\frac{3.71}{{D}^{3} * X}} .$$

2. The metal halide lamp according to claim 1, the discharge tube being of tubular shape, and 0.7<X<4.

3. The metal halide lamp according to claim 1, wherein 1.4 mm≦D<8 mm, preferably 2 mm≦D≦7 mm.

4. The metal halide lamp according to claim 1, wherein the rated power of the lamp is at most 100 W.
